(19) United States
(12) Patent Application Publication
(10) Pub. No.: US 2025/0181039 A1
(43) Pub. Date: Jun. 5, 2025

(54) CONTROL UNIT FOR VIBRATOR OF HAPTIC DEVICE AND HAPTIC DEVICE

(71) Applicant: Murata Manufacturing Co., Ltd., Kyoto (JP)

(72) Inventor: Norio NAKAMURA, Kyoto (JP)

(21) Appl. No.: 19/042,763

(22) Filed: Jan. 31, 2025

Related U.S. Application Data
(63) Continuation of application No. PCT/JP2023/027175, filed on Jul. 25, 2023.

(30) Foreign Application Priority Data
Aug. 1, 2022 (JP) 2022-122719

(51) Int. Cl. G05B 13/02

(52) U.S. Cl. CPC G05B 13/027; G05B 2219/39241; G05B 2219/40619

(57) ABSTRACT

A control unit includes a CPU as an execution unit and a storage. The storage stores vibration mode data indicating multiple vibration modes used for rehabilitation. The storage stores model data which determines a learning model. A body condition variable indicating body information of a user is input into the learning model and a mode variable is output from the learning model. The mode variable indicates a pattern of a vibration mode that represents a tactile/force sense to output from a haptic device. The model data is learned data obtained by machine learning. In obtaining processing, the CPU obtains multiple body condition variables of the user. In mode selection processing, the CPU selects a specific mode, based on mode variables output by using the multiple body condition variables obtained in the mode obtaining processing as input variables. In driving processing, the CPU drives a vibrator by using the specific mode.

### CROSS REFERENCE TO RELATED APPLICATION

This is a continuation of International Application No. PCT/JP2023/027175 filed on Jul. 25, 2023 which claims priority from Japanese Patent Application No. 2022-122719 filed on Aug. 1, 2022. The contents of these applications are incorporated herein by reference in their entireties.

### BACKGROUND ART

### Technical Field

The present disclosure relates to a control unit for a vibrator of a haptic device and also to the haptic device.

### Background Art

A haptic device disclosed in Patent Document 1 includes a casing, a vibrator, and a control unit. The vibrator is disposed inside the casing. A user holds the casing with a hand, for example, to use the haptic device. The control unit performs control to set the vibration pattern of the vibrator to a specific pattern. The haptic device can thus present various tactile/force senses to the user holding the casing.

Patent Document 1: Japanese Unexamined Patent Application Publication No. 2005-190465

### BRIEF SUMMARY

One of the situations where a user uses a haptic device such as that disclosed in Patent Document 1 may be that a user uses the haptic device as an assistive instrument to undergo rehabilitation to recover from a movement disorder. In this case, however, it is uncertain which type of tactile/force sense is to be presented to the user to enhance the effect of recovering from a movement disorder.

To solve the above-described problem, an aspect of the present disclosure provides a control unit for a vibrator of a haptic device. The control unit includes a storage and an execution unit. The control unit controls the vibrator of the haptic device. The storage stores vibration mode data and model data which determines a learning model. The vibration mode data indicates multiple vibration modes used for rehabilitation. A body condition variable indicating a body condition of a user is input into the learning model and a mode variable is output from the learning model. The mode variable indicates a pattern of a vibration mode of the multiple vibration modes that represents a tactile/force sense to be output from the haptic device. The model data is learned data obtained by machine learning. The execution unit executes: obtaining processing for obtaining multiple body condition variables of the user; mode selection processing for selecting a specific mode from the multiple vibration modes, based on the mode variables which are output by using the multiple body condition variables obtained in the obtaining processing as input variables; and driving processing for driving the vibrator by using the specific mode selected in the mode selection processing.

To solve the above-described problem, an aspect of the present disclosure provides a haptic device including a vibrator and a control unit. The control unit includes a storage and an execution unit and controls the vibrator. The storage stores vibration mode data and model data which determines a learning model. The vibration mode data indicates multiple vibration modes used for rehabilitation. A body condition variable indicating a body condition of a user is input into the learning model and a mode variable is output from the learning model. The mode variable indicates a pattern of a vibration mode of the multiple vibration modes that represents a tactile/force sense. The model data is learned data obtained by machine learning. The execution unit executes: obtaining processing for obtaining multiple body condition variables of the user; mode selection processing for selecting a specific mode from the multiple vibration modes, based on the mode variables which are output by using the multiple body condition variables obtained in the obtaining processing as input variables; and driving processing for driving the vibrator by using the specific mode selected in the mode selection processing.

With the above-described configurations, in accordance with the body condition of a user, a vibration mode that presents a suitable tactile/force sense can be selected. That is, a suitable tactile/force sense can be presented in accordance with the body condition of a user.

A suitable tactile/force sense can be presented in accordance with the body condition of a user.

### BRIEF DESCRIPTION OF THE DRAWINGS

FIG. 1 is a schematic diagram illustrating a haptic device.

FIG. 2 is a schematic diagram illustrating a learning model.

FIG. 3 is a flowchart illustrating a series of operations executed in accordance with a control program.

FIG. 4 is a schematic diagram illustrating a learning system.

FIG. 5 is a flowchart illustrating a series of operations executed in accordance with a learning program.

### DETAILED DESCRIPTION

### Embodiment

An embodiment of a control unit for a haptic (tactile/force sense presenting) device will be described below with reference to the drawings. The haptic device will first be explained below.

### <Haptic Device>

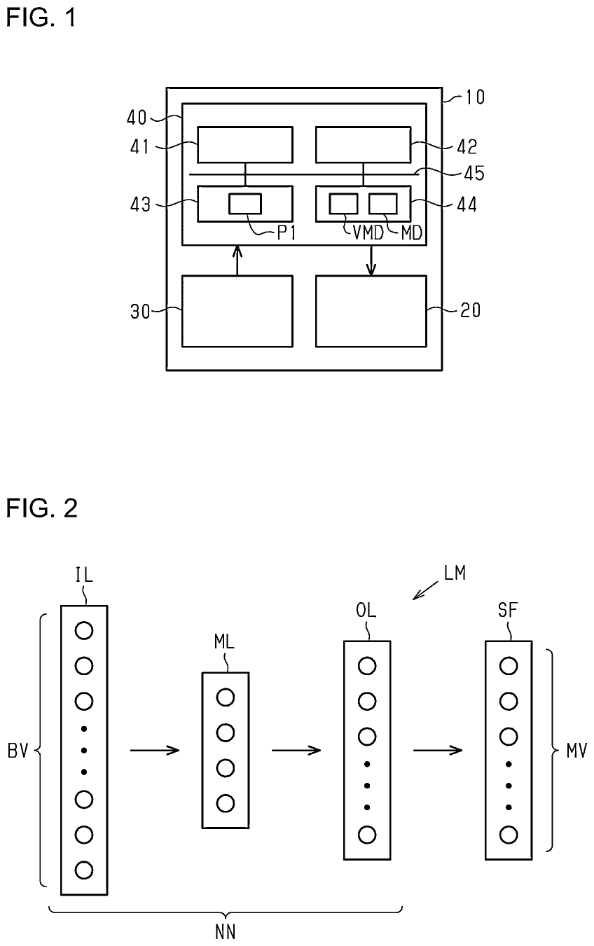

As illustrated in FIG. 1, a haptic device 10 includes a vibrator 20, an input/output unit 30, and a control unit 40.

The vibrator 20 is stored inside a casing of the haptic device 10, though such a state is not shown. The vibrator 20 includes voice coil motors, weights for the respective voice coil motors, and a cubic casing for storing the voice coil motors and the weights. A current flows through a coil of the voice coil motor to generate force, which vibrates the weight. In accordance with the vibration of the weight, the casing is vibrated. As a result of controlling a current to flow through the coil of the voice coil motor, the vibrator 20 is vibrated in a direction along the axis perpendicular to the surface of the casing. Specifically, the vibrator 20 is a vibrator such as that disclosed in Japanese Unexamined Patent Application Publication No. 2005-190465, for example.

The input/output unit 30 is a device used by a user to input a body condition variable BV. The input/output unit 30 is constituted by a touch screen display, for example. The input/output unit 30 can present information to a user in the form of an image. The input/output unit 30 is operated by a user. Multiple body condition variables BV indicating body condition information are input into the input/output unit 30 by a user operation.

More specifically, two or more of the multiple body condition variables BV are variables regarding predetermined physical disabilities which each indicates whether a user has a corresponding physical disability. For example, if the number of types of predetermined physical disabilities is n, n body condition variables BV are variables which each indicates whether a user has a corresponding physical disability. If the user has a first type of physical disability, 1 is input as the corresponding body condition variable BV. Likewise, if the user has a second type of physical disability, 1 is input as the corresponding body condition variable BV. In contrast, if the user does not have a certain type of physical disability, 0 is input as the corresponding body condition variable BV.

Two or more of the multiple body condition variables BV are variables which each indicates the degree of a predetermined physical disability. For example, if the number of types of predetermined physical disabilities is n, n body condition variables BV are variables which each indicates the degree of a corresponding physical disability. For example, as the degree of a certain type of physical disability is higher, the corresponding body condition variable BV becomes closer to 1. As the degree of a certain type of physical disability is lower, the corresponding body condition variable BV becomes closer to 0. In the embodiment, if a user does not have a certain type of physical disability, the corresponding body condition variable BV is set to 0.

One of the multiple body condition variables BV is a variable which indicates the age of a user. One of the multiple body condition variables BV is a variable which indicates a body part to undergo rehabilitation. One of the multiple body condition variables BV is a variable which indicates the height of a user. One of the multiple body condition variables BV is a variable which indicates the weight of a user.

The control unit 40 controls the vibrator 20. The control unit 40 performs control to set the vibration pattern of the vibrator 20 to a specific vibration pattern corresponding to a tactile/force sense to be presented. The vibration pattern is a pattern of vibration represented by a nonlinear wave, for example. With this vibration pattern, the haptic device 10 presents a tactile sense or a force sense to a user. The tactile/force sense includes a tactile/force illusion sense. The tactile/force illusion sense includes a tactile illusion sense and a force illusion sense. The tactile illusion sense is the following type of sense of illusion. When vibrations of the vibrator 20 are given to a user, the user feels as if he/she were touching an uneven shape. The force illusion sense is the following type of sense of illusion. When vibrations of the vibrator 20 are given to a user, the user feels as if force were applied to the user.

The control unit 40 includes a CPU 41, which serves as an execution unit, a peripheral circuit 42, a ROM 43, a storage 44, and a bus 45. The bus 45 connects the CPU 41, peripheral device 42, ROM 43, and storage 44 so that they can communicate with each other. The peripheral circuit 42 includes various circuits, such as a circuit that generates a clock signal which determines the internal operation, a power supply circuit, and a reset circuit. In the ROM 43, various programs to be used by the CPU 41 to perform various control operations are stored. Among others, the ROM 43 stores a control program P1 to be used by the CPU 41 to perform control based on a learning model LM, which will be discussed later. The CPU 41 controls the vibrator 20 by executing various programs stored in the ROM 43.

The storage 44 stores vibration mode data VMD indicating multiple vibration modes VM used for rehabilitation. The vibration mode VM is a mode for presenting a tactile/force sense suitable for a rehabilitation pattern or a combination of rehabilitation patterns.

The storage 44 also stores data indicating vibration patterns of the vibrator 20 for implementing the corresponding vibration modes VM. The tactile/force sense to be presented by the haptic device 10 is determined by this data stored in the storage 44.

The storage 44 stores model data MD, which is data for determining a learning model LM. As shown in FIG. 2, the learning model LM is constituted by, for example, a neural network NN and a softmax function SF that standardizes the output of the neural network NN.

The neural network NN includes an input layer IL, a middle layer ML, and an output layer OL. The input layer IL has multiple nodes. The number of nodes is equal to the number of body condition variables BV indicating the body condition of a user. The neural network NN has an activation function in the middle layer ML. The activation function is a hyperbolic tangent, for example. The output layer OL outputs the precision of each vibration mode VM.

The softmax function SF is a function that converts the sum of the precision values of the individual vibration modes VM that are output to the output layer OL into “1”. Hence, the precision of each vibration mode VM that is output to the output layer OL is standardized by the softmax function SF and is output from the learning model LM.

In the learning model LM configured as described above, as a result of inputting multilevel input variables into the input layer IL, the sum of the values obtained by the multiplication of weights in accordance with individual transfer paths is input into the activation function. Then, the output value of the activation function is input into the subsequent layer. By repeating this operation, the precision of each vibration mode VM is output from the output layer OL. Then, the precision of each vibration mode VM is standardized by the softmax function SF and is output. The transfer paths that link nodes of a layer and nodes of an adjacent layer are not shown in FIG. 2.

The model data MD is data indicating a learning model LM. The model data MD thus includes data indicating the weight corresponding to each transfer path which is updated by learning.

### <Control Operation Based on Learning Data>

As illustrated in FIG. 1, the CPU 41 executes the control program P1 stored in the ROM 43 so as to perform a series of operations for controlling the vibrator 20. The CPU 41 can thus execute obtaining processing for obtaining multiple body condition variables BV of a user, mode selection processing for selecting a specific mode SM from multiple vibration modes VM, and driving processing for driving the vibrator 20 by using the specific mode SM.

When the haptic device 10 is powered ON, the CPU 41 executes the control program P1 stored in the ROM 43. The haptic device 10 is powered ON as a result of the input/output unit 30 being operated when the power of the haptic device 10 is OFF, for example. The control program P1 is a program for causing the CPU 41 to execute the obtaining processing, mode selection processing, and driving processing.

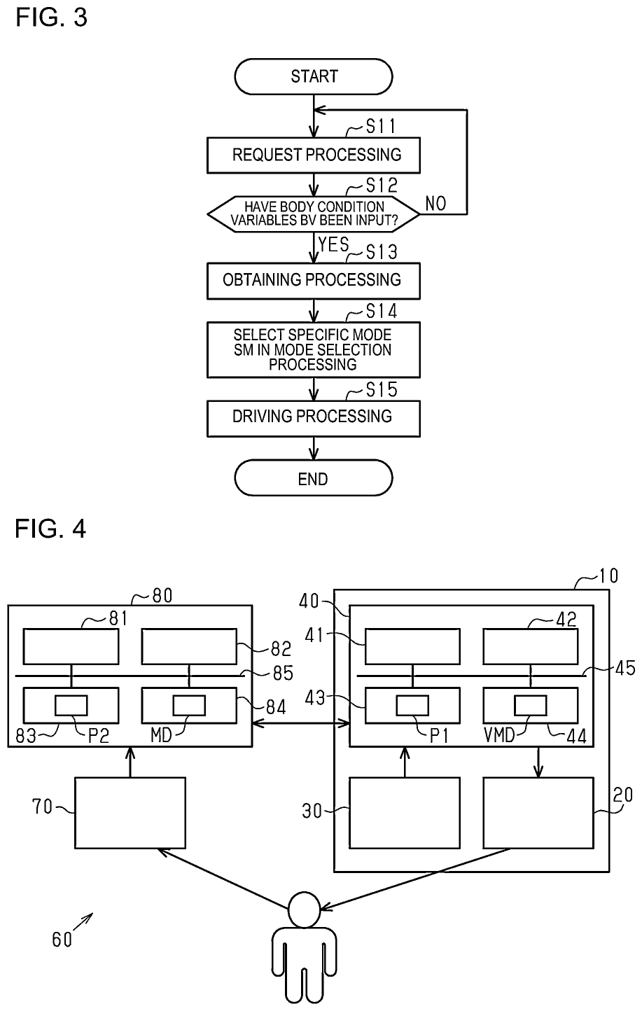

As illustrated in FIG. 3, after starting the control program P1, the CPU 41 first executes step S11. In step S11, the CPU 41 executes request processing. More specifically, in the request processing, the CPU 41 outputs image data of required body condition variables BV indicating body condition information of a user to the input/output unit 30 so that the user can perform selection operation. That is, the input/output unit 30 displays icons representing input fields for the individual body condition variables BV on the touch screen display.

More specifically, in the request processing, for predetermined multiple physical disabilities, the CPU 41 outputs the name of each physical disability and options regarding whether the user has a corresponding physical disability. The input results obtained from the user can be handled as body condition variables BV indicating whether the user has the corresponding physical disabilities.

In the request processing, the CPU 41 also outputs input fields for information on the degrees of the individual physical disabilities corresponding to their names and options to be selectively input into these input fields. Examples of the options are three degrees, such as “severe”, “intermediate”, and “mild”. If “NO” is selected from the options regarding whether a user has a corresponding physical disability, the CPU 41 does not output the input field and the options for information on the degree of this physical disability. The input results obtained from the user can be handled as body condition variables BV indicating the degrees of the physical disabilities. If the user does not have a certain physical disability, it is assumed that 0 is input as the body condition variable BV indicating the degree of this physical disability.

In the request processing, the CPU 41 also outputs an input field for the age of the user and options that can be selectively input into this input field. Examples of the options are integers from 10 to 100. The input result obtained from the user can be handled as a body condition variable BV indicating the age of the user. The CPU 41 also outputs an input field for a body part to undergo rehabilitation and options that can be selectively input into this input field. Examples of the options are body parts, such as the right arm, left arm, right foot, and left leg. The input result obtained from the user can be handled as a body condition variable BV indicating the body part to undergo rehabilitation.

The above-described selection fields may be displayed at the same time on one screen of the input/output unit 30, or every time one option is selected, the next options may be displayed. The CPU 41 then proceeds to step S12.

In step S12, the CPU 41 determines whether the user has input body condition variables BV. More specifically, the CPU 41 determines whether the user has selected options for all the fields in the request processing in step S11. If the user has selected options for all the fields, the CPU 41 determines that the user has input body condition variables BV using the input/output unit 30. If the user has not selected options for some of the fields, the CPU 41 determines that the user has not yet input body condition variables BV using the input/output unit 30.

If the user has not yet input all the body condition variables BV using the input/output unit 30 (S12: NO), the CPU 41 returns to step S11. If the user has input all the body condition variables BV using the input/output unit 30 (S12: YES), the CPU 41 proceeds to step S13.

In step S13, the CPU 41 executes obtaining processing. In the obtaining processing, the CPU 41 obtains body condition variables BV. More specifically, the CPU 41 obtains body condition variables BV corresponding to the options input into the input/output unit 30. The CPU 41 then proceeds to step S14.

In step S14, the CPU 41 executes mode selection processing. In the mode selection processing, the CPU 41 inputs the body condition variables BV obtained in the obtaining processing into the learning model LM as input variables. The CPU 41 then selects a specific mode SM from the vibration modes VM, based on mode variables MV output from the learning model LM. More specifically, the CPU 41 obtains the precision of each vibration mode VM output from the learning model LM as a mode variable MV, which is an output variable. The CPU 41 then selects, as the specific mode SM, the vibration mode VM having the highest precision among the precisions of the individual vibration modes VM. The CPU 41 then proceeds to step S15.

In step S15, the CPU 41 executes driving processing. In the driving processing, the CPU 41 drives the vibrator 20 by using the specific mode SM selected in the mode selection processing. While the haptic device 10 is being driven in this manner in the specific mode SM, the user undergoes rehabilitation by using the haptic device 10 as an assistive instrument. That is, the user performs physical exercises related to the rehabilitation while receiving the presentation of a tactile/force sense from the haptic device 10. After executing the driving processing for a certain time, the CPU 41 completes a series of operations.

### <Learning System>

### <Learning Method for Learning Model>

A learning method for a learning model LM will be described below. A learning system 60 that generates model data MD which determines a learning model LM will first be discussed.

As illustrated in FIG. 4, the learning system 60 includes the above-described haptic device 10, a measuring device 70, and a setting device 80. The devices of the learning system 60 are connected to each other so as to communicate with each other.

The measuring device 70 is a device that measures an activation parameter indicating the activation state of a user having received a tactile/force sense from the haptic device 10. For example, the measuring device 70 measures the activation state of the brain of a user. More specifically, the measuring device 70 is a brain measuring instrument using near-infrared spectroscopy.

The measuring device 70 measures activation parameters of individual portions of the brain. For example, the measuring device 70 measures the blood flow rate of an individual portion of the brain as the activation parameter. As the blood flow rate is higher, the degree of the brain activation is higher. The measuring device 70 measures the activation parameters of portions of the primary motor cortex of the brain corresponding to individual body parts. The measuring device 70 then sends the activation parameters of the individual portions of the brain to the setting device 80.

The setting device 80 is a device for updating the model data MD indicating the learning model LM. The setting device 80 controls the vibrator 20 of the haptic device 10 via the control unit 40. The setting device 80 includes a CPU 81, a peripheral circuit 82, a ROM 83, a storage 84, and a bus 85. The bus 85 connects the CPU 81, peripheral device 82, ROM 83, and storage 84 so that they can communicate with each other. The peripheral circuit 82 includes various circuits, such as a circuit that generates a clock signal which determines the internal operation, a power supply circuit, and a reset circuit. In the ROM 83, various programs to be used by the CPU 81 to perform various control operations are stored. Among others, a learning program P2 for the learning of the learning model LM is stored in the ROM 83. The CPU 81 executes the learning program P2 stored in the ROM 83 so as to conduct learning of the learning model LM. The storage 84 stores model data MD that determines the learning model LM.

The CPU 81 executes the learning program P2 stored in the ROM 83 so as to perform a series of operations for conducting learning of the learning model LM. As a training data generating step, the CPU 81 can thus execute test driving processing, parameter obtaining processing, and a correct label determining processing, all of which will be discussed later. The CPU 81 also executes model calculating processing and model updating processing as a model data updating step.

When the haptic device 10 is powered ON in a state in which the haptic device 10, the measuring device 70, and the setting device 80 are connected to each other, the CPU 81 executes the learning program P2 stored in the ROM 83. That is, the learning program P2 is a program for causing the CPU 81 to execute the training data generating step and the model data updating step.

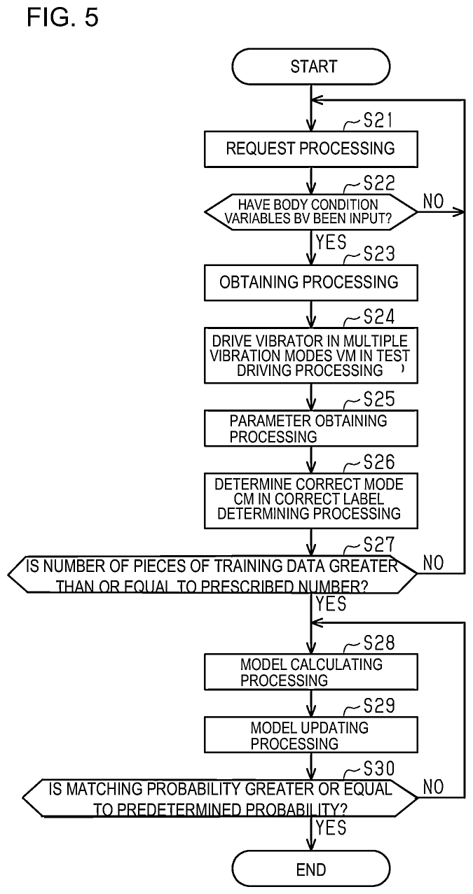

As illustrated in FIG. 5, after starting the learning program P2, the CPU 81 first executes steps S21 through S23. Steps S21 through S23 are similar to steps S11 through S13 of the above-described control program P1. After step S23, the CPU 81 proceeds to step S24.

In step S24, the CPU 81 starts test driving processing. In the test driving processing, the CPU 81 drives the vibrator 20 in multiple vibration modes VM in a predetermined order for a predetermined period. In the test driving processing, the CPU 81 starts measuring the activation state of the brain of a user by using the measuring device 70. During the execution of the test driving processing, the user can undergoes rehabilitation using the haptic device 10 as an assistive instrument. The CPU 81 then proceeds to step S25.

In step S25, the CPU 81 executes parameter obtaining processing. In the parameter obtaining processing, the CPU 81 obtains the activation parameters which were measured by the measuring device 70 when the vibrator 20 was vibrated in the individual vibration modes VM. After the parameter obtaining processing has been completed, the CPU 81 proceeds to step S26.

In step S26, the CPU 81 executes correct label determining processing. In the correct label determining processing, the CPU 81 determines a correct mode CM, which is to be selected as a specific mode SM from among multiple vibration modes VM, based on the activation parameters measured for the individual vibration modes VM and obtained in the parameter obtaining processing. The CPU 81 then sets the correct mode CM as a correct label.

This will be explained more specifically. First, the CPU 81 outputs the activation parameters of the individual brain parts that are obtained while the vibrator 20 was vibrated in the first vibration mode VM. At this time, the CPU 81 may output the values of the activation parameters or output the activation parameters of the individual brain parts in the form of visual images. Then, the CPU 81 outputs the activation parameters of the individual brain parts that are obtained while the vibrator 20 was vibrated in the second and subsequent vibration modes VM.

A healthcare professional, such as a medical doctor or a physical therapist, refers to the activation parameters of the individual brain parts that are output as described above and examines the reaction of the user receiving the presentation of tactile/force senses in the individual vibration modes VM. Taking these factors into consideration, the healthcare professional determines the vibration mode VM that is probably likely to be the most effective as the correct mode CM. The healthcare professional then inputs the correct mode CM into the input/output unit 30 of the haptic device 10. In this manner, in response to the multiple body condition variables BV obtained in the obtaining processing, the CPU 81 determines the correct mode CM as a correct label for these body condition variables BV and generates a set of training data. The CPU 81 then proceeds to step S27.

In step S27, the CPU 81 determines whether the number of pieces of training data is greater than or equal to a prescribed number. If the number of pieces of training data is smaller than the prescribed number (S27: NO), the CPU 81 repeats steps S21 through S26 for another user or another body part to undergo rehabilitation. If the number of pieces of training data is greater than or equal to the prescribed number (S27: YES), the CPU 81 proceeds to step S28.

In step S28, the CPU 81 executes model calculating processing. In the model calculating processing, for each piece of training data, the CPU 81 inputs, as input data, data concerning the multiple body condition variables BV obtained in the obtaining processing into the input layer IL of the learning model LM and calculates the precision of each vibration mode VM. The CPU 81 then proceeds to step S29.

In step S29, the CPU 81 executes model updating processing. In the model updating processing, the CPU 81 adjusts the weights used in the neural network NN so as to increase the probability that the precision of each vibration mode VM calculated in the model calculating processing matches the corresponding correct label.

This will be explained more specifically. Regarding a set of training data, the CPU 81 calculates the sum of the precision values of the individual vibration modes VM as “1”. Then, the CPU 81 checks the vibration mode VM having the highest precision value and the vibration mode VM represented by the correct label against each other. If the two vibration modes VM match each other, the CPU 81 determines that the result of the model calculating processing for this piece of training data matches the correct label. The CPU 81 repeats this operation the same number of times as the number of pieces of training data. Then, the CPU 81 calculates the ratio of the number of pieces of training data for which the result of the model calculating processing is found to match the correct label to the total number of pieces of training data and determines this ratio to the matching probability. The CPU 81 then proceeds to step S30.

In step S30, the CPU 81 determines whether the matching probability that the precision of a certain vibration mode VM calculated in the model calculating processing is found to match the correct label is greater than or equal to a predetermined probability. If the matching probability is smaller than the predetermined probability (S30: NO), the CPU 81 repeats steps S28 and S29. If the matching probability is greater than or equal to the predetermined probability (S30: YES), the CPU 81 determines that learning is completed. Then, the CPU 81 updates the model data MD that determines the learning model LM and sets it to learned data. The CPU 81 then completes a series of operations.

### <Operation of Embodiment>

According to the above-described embodiment, when using the haptic device 10, a user, who is a patient, for example, inputs multiple body condition variables BV indicating the body condition of the user. The haptic device 10 selects a specific mode SM from multiple vibration modes VM, based on the output of the learning model LM obtained when these body condition variables BV are input into the learning model LM.

### <Effects of Embodiment>

(1) In the above-described embodiment, in the mode selection processing, the haptic device 10 selects a specific mode SM from multiple vibration modes VM, based on mode variables MV output from a learning model LM. Hence, in accordance with body condition variables BV of a user, the haptic device 10 can drive the vibrator 20 by using the vibration mode VM which presents a suitable tactile/force sense to the user. That is, the user inputs his/her body condition variables BV and can undergo rehabilitation while receiving the presentation of a suitable tactile/force sense among the tactile/force senses that the haptic device 10 can present.

In the above-described embodiment, the number of combinations of multiple body condition variables BV may become an enormous number. It is thus time- and effort-consuming to correlate each combination pattern to a certain vibration mode VM based on a predetermined rule. Additionally, the levels of body condition variables BV and optimal vibration modes VM are not necessarily simply correlated to each other, and it may be difficult to find a definite regularity between the two factors. From this point of view, in the above-described embodiment, a specific mode SM is selected with the use of a learning model LM represented by learned model data MD obtained by machine learning. With this configuration, a healthcare professional is able to select, as a specific mode SM, a vibration mode VM that represents a tactile/force sense, which can be expected to be suitable, based on his/her experience, even though such an operation does not cover all the combinations of multiple body condition variables BV.

(2) In the above-described embodiment, two or more of the multiple body condition variables BV are variables which each indicates whether a user has a certain physical disability. With this configuration, a suitable tactile/sense force can be presented in accordance with whether the user has certain physical disabilities.

(3) In the above-described embodiment, two or more of the multiple body condition variables BV are variables which each indicates the degree of a certain physical disability. With this configuration, a suitable tactile/sense force can be presented in accordance with the degrees of certain physical disabilities.

(4) According to the learning method for a learning model LM in the above-described embodiment, a correct label is selected by a healthcare professional based on the activation state of the body of a user, more specifically, the activation states of individual parts of the brain of the user, at the time of driving the vibrator 20 in multiple vibration modes VM. The experience of a healthcare professional, which is difficult to be formed into a mathematical expression or a map, can thus be reflected in a learning model LM. This can save a healthcare professional selecting a vibration mode VM every time a user uses the haptic device 10, and the user can use the haptic device 10 in the vibration mode VM that is probably likely to be the most effective.

(5) When a tactile/force sense is presented to a user, even if some body parts of the user, such as the arms and the legs, are not physically moved, portions of the primary motor cortex of the brain corresponding to such body parts may be activated. According to the learning method for a learning model LM in the above-described embodiment, when a healthcare professional is to select a correct label, activation parameters of individual parts of the brain of a user are measured. Hence, for example, even when the corresponding body parts of the user are not physically moved, the healthcare professional can select a correct label, which is effective in terms of the activation of the brain, by referring to the activation parameters.

### Other Embodiments

The above-described embodiment may be modified in the following manner and be carried out. The embodiment and the following modified examples may be combined with each other and be carried out as long as the resulting configurations do not become technically inconsistent.

In the above-described embodiment, the configuration of the vibrator 20 is not limited to that of the embodiment. For example, the vibrator 20 may be a vibrator using vibrations of a motor or a vibrator including a piezoelectric element.

Plural vibrators 20 may be provided. In this case, the vibration mode VM may include information indicating regarding whether each of the vibrators 20 is vibrated and the vibration order of the vibrators 20. This can enhance the variety of patterns of vibration modes VM.

In the above-described embodiment, the control unit 40 is not limited to a device that includes a CPU and a ROM and executes software processing. For example, some of the software operations in the above-described embodiment may be executed by a hardware circuit (an ASIC, for example) dedicated to hardware processing. That is, the control unit 40 may have any one of the following configurations (a) through (c): (a) the control unit 40 includes a processor that executes all the above-described processing operations in accordance with a program and a program storage unit, such as a ROM; (b) the control unit 40 includes a processor that executes some of the above-described processing operations in accordance with a program, a program storage unit, and a dedicated hardware circuit that executes the remaining processing operations; and (c) the control unit 40 includes a dedicated hardware circuit that executes all the above-described processing operations. In the above-described configurations, multiple software execution units each including a processor and a program storage unit and multiple dedicated hardware circuits may be provided. Likewise, the configuration of the setting device 80 may be modified similarly to the control unit 40.

Only one of the multiple body condition variables BV may be a variable indicating whether a user has a physical disability. Additionally, only one of the multiple body condition variables BV may be a variable indicating the degree of a physical disability. For example, when a tactile/force sense is presented to a user having a specific physical disability, if the body condition variable BV regarding this specific physical disability is obtained, the provision of the variables for other physical disabilities may be omitted.

The body condition variable BV may be a variable indicating any state of a user if it represents body information of the user. For example, a variable regarding whether a user has a physical disability may be omitted from the multiple body condition variables BV. A variable indicating the degree of a physical disability of a user may be omitted from the multiple body condition variables BV.

Additionally, a variable indicating a body part to undergo rehabilitation may be omitted from the multiple body condition variables BV. In this case, if a user has only one physical disability, the body part to undergo rehabilitation corresponding to this physical disability may be estimated. The multiple body condition variables BV may include information other than those discussed in the embodiment. For example, the multiple body condition variables BV may include a variable indicating the blood pressure of a user.

The learning model LM is not limited to a model learned by the learning method discussed in the embodiment. The model data MD may be any data if it is learned by machine learning. For example, the learning method for the learning model LM is not limited to supervised learning, and the learning model LM may be a model represented by model data MD learned by reinforcement learning. The control program P1 may be executed by using a learning model LM learned by another type of machine learning.

Determining a correct label in the learning method for the learning model LM is not limited to the example in the embodiment. For example, the vibration mode VM that can maximize the activation parameters of the brain may be set to a correct label.

The configuration of the learning model LM is not limited to the example in the embodiment. For example, although only one middle layer ML is shown in the neural network NN in FIG. 2, the neural network NN may have plural middle layers ML.

The vibration mode VM may be a mode that presents only a tactile sense or a mode that presents only a force sense.

In the request processing, instead of outputting options, a user may be instructed to input data in text format. The content of request processing may be suitably changed in accordance with the input/output unit 30.

In step S12, if an input completion button is displayed on the input/output unit 30, when this input completion button is pressed, the CPU 41 may assume that a user has finished inputting information.

The measuring device 70 is not limited to a brain measuring instrument using near-infrared spectroscopy. For example, the measuring device 70 may be a measuring instrument using functional magnetic resonance imaging (MRI). In another example, the measuring device 70 may be a measuring instrument using electroencephalography (EEG).

The measuring device 70 is not necessarily a device that measures the activation state of the brain of a user. For example, the measuring device 70 may be a device that measures the activation state of a specific body part other than the brain. As a specific example, if the body part of a user to undergo rehabilitation is the right leg, the measuring device 70 may be a device that measures the activation state of the right leg.

The setting device 80 may control the vibrator 20 without the intervention of the control unit 40. For example, if the storage 84 of the setting device 80 stores data indicating multiple vibration modes VM, the CPU 81 may drive the vibrator 20 by using this data in the test driving processing.

The technical concepts that can be derived from the above-described embodiment and modified examples will be described below.

### <Appendix 1>

A control unit for a vibrator of a haptic device, comprising:
a storage; and
an execution unit, wherein
the control unit controls the vibrator of the haptic device,
the storage stores a plurality of vibration modes used for rehabilitation and model data which determines a learning model, a plurality of body condition variables indicating a body condition of a user being input into the learning model and a mode variable being output from the learning model, the mode variable indicating a pattern of a vibration mode of the plurality of the vibration modes that represents a tactile/force sense to be output from the haptic device,
the model data is learned data obtained by machine learning, and
the execution unit executes
   obtaining processing for obtaining a plurality of the body condition variables of the user,
   mode selection processing for selecting a specific mode from the plurality of the vibration modes, based on the mode variables which are output by using the plurality of the body condition variables obtained in the obtaining processing as input variables, and
   driving processing for driving the vibrator by using the specific mode selected in the mode selection processing.

### <Appendix 2>

The control unit according to <Appendix 1>, wherein one of the plurality of the body condition variables is a variable indicating whether the user has a physical disability.

### <Appendix 3>

The control unit according to <Appendix 2>, wherein one of the plurality of the body condition variables is a variable indicating a degree of the physical disability of the user.

### <Appendix 4>

The control unit according to one of <Appendix 1> to <Appendix 3>, wherein two or more of the plurality of the body condition variables are variables regarding a plurality of predetermined physical disabilities, each of the variables indicating whether a user has a corresponding physical disability.

### <Appendix 5>

The control unit according to <Appendix 4>, wherein two or more of the plurality of the body condition variables are variables regarding the plurality of the predetermined physical disabilities, each of the variables indicating a degree of a corresponding physical disability of the user.

### <Appendix 6>

The control unit according to one of <Appendix 1> to <Appendix 5>, wherein:
the haptic device includes a plurality of the vibrators; and
the vibration modes include information regarding whether each of the plurality of the vibrators is vibrated and a vibration order of the vibrators.

### <Appendix 7>

A haptic device comprising:
a vibrator; and
a control unit that includes a storage and an execution unit and controls the vibrator, wherein
the storage stores vibration mode data and model data which determines a learning model, the vibration mode data indicating a plurality of vibration modes used for rehabilitation, a body condition variable indicating a body condition of a user being input into the learning model and a mode variable being output from the learning model, the mode variable indicating a pattern of a vibration mode of the plurality of the vibration modes that represents a tactile/force sense,
the model data is learned data obtained by machine learning, and
the execution unit executes
   obtaining processing for obtaining a plurality of the body condition variables of the user,
   mode selection processing for selecting a specific mode from the plurality of the vibration modes, based on the mode variables which are output by using the plurality of the body condition variables obtained in the obtaining processing as input variables, and
   driving processing for driving the vibrator by using the specific mode selected in the mode selection processing.

### REFERENCE SIGNS LIST

10 haptic device
20 vibrator
30 input/output unit
40 control unit
41 CPU
42 peripheral circuit
43 ROM
44 storage
45 bus
60 learning system
70 measuring device
80 setting device
BV body condition variable
CM correct mode
IL input layer
LM learning model
MD model data
ML middle layer
MV mode variable
NN neural network
OL output layer
P1 control program
P2 learning program
SF softmax function
SM specific mode
VM vibration mode
VMD vibration mode data

1. A control unit for a vibrator of a haptic device, comprising:
a storage; and
at least one processor,
wherein the control unit is configured to control the vibrator,
wherein the storage is configured to store vibration mode data and model data which represents a learning model, the vibration mode data indicating a plurality of vibration modes used for rehabilitation, a plurality of body conditions variable indicating a body condition of a user being input into the learning model, and a mode variable being output from the learning model, the mode variable indicating a pattern of a vibration mode of the plurality of the vibration modes that represents a tactile/force sense output from the haptic device,
wherein the model data is learned data obtained by machine learning, and
wherein the processor is configured to:
obtain a plurality of the body condition variables of the user,
select a specific mode from the plurality of the vibration modes, based on the mode variables which are output from the learning model by using the plurality of the body condition variables of the user as input variables, and
drive the vibrator by using the specific mode selected in the mode selection processing.

2. The control unit according to claim 1, wherein one of the plurality of the body condition variables indicates whether the user has a physical disability.

3. The control unit according to claim 2, wherein one of the plurality of the body condition variables indicates a degree of the physical disability of the user.

4. The control unit according to claim 1, wherein two or more of the plurality of the body condition variables relate to a plurality of predetermined physical disabilities, each of the variables indicating whether a user has a corresponding physical disability.

5. The control unit according to claim 4, wherein two or more of the plurality of the body condition variables relate to the plurality of the predetermined physical disabilities, each of the variables indicating a degree of a corresponding physical disability of the user.

6. The control unit according to claim 1,
wherein the haptic device comprises a plurality of vibrators, and
wherein the vibration modes relate to whether each of the plurality of the vibrators is vibrated and a vibration order of the vibrators.

7. A haptic device comprising:
a vibrator; and
a control unit that comprising a storage and a processor, and that is configured to control the vibrator,
wherein the storage is configured to store vibration mode data and model data which represents a learning model, the vibration mode data indicating a plurality of vibration modes used for rehabilitation, a body condition variable indicating a body condition of a user being input into the learning model and a mode variable being output from the learning model, the mode variable indicating a pattern of a vibration mode of the plurality of the vibration modes that represents a tactile/force sense,
wherein the model data is learned data obtained by machine learning, and
wherein the processor is configured to:
obtain a plurality of the body condition variables of the user,
select a specific mode from the plurality of the vibration modes, based on the mode variables which are output by using the plurality of the body condition variables as input variables, and
drive the vibrator by using the specific mode selected in the mode selection processing.

8. The control unit according to claim 2, wherein two or more of the plurality of the body condition variables relate to a plurality of predetermined physical disabilities, each of the variables are configured to indicate whether a user has a corresponding physical disability.

9. The control unit according to claim 3, wherein two or more of the plurality of the body condition variables relate to a plurality of predetermined physical disabilities, each of the variables are configured to indicate whether a user has a corresponding physical disability.

10. The control unit according to claim 2,
wherein the haptic device comprises a plurality of vibrators, and
wherein the vibration modes relate to whether each of the plurality of the vibrators is vibrated and a vibration order of the vibrators.

11. The control unit according to claim 3,
wherein the haptic device comprises a plurality of vibrators, and
wherein the vibration modes relate to whether each of the plurality of the vibrators is vibrated and a vibration order of the vibrators.

12. The control unit according to claim 4,
wherein the haptic device comprises a plurality of vibrators, and
wherein the vibration modes relate to whether each of the plurality of the vibrators is vibrated and a vibration order of the vibrators.

13. The control unit according to claim 5,
wherein the haptic device comprises a plurality of vibrators, and
wherein the vibration modes relate to whether each of the plurality of the vibrators is vibrated and a vibration order of the vibrators.
